(19) United States
(12) Patent Application Publication
(10) Pub. No.: US 2007/0121020 A1
(43) Pub. Date: May 31, 2007

(54) Information processing device and control method for information processing device

(75) Inventor: Tetsunari Ichimura, Tokyo (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Kabushiki Kaisha Toshiba

(21) Appl. No.: 11/398,238

(22) Filed: Apr. 5, 2006

(30) Foreign Application Priority Data
Oct. 31, 2005 (JP) P2005-317693

(51) Int. Cl. H04N 5/66; H04N 9/12

(52) U.S. Cl. 348/739

(57) ABSTRACT

According to one embodiment, an information processing device includes a display panel, a viewing angle control filter configured to control a viewing angle, a connector to which an external display is connectable, and an inhibit unit configured to inhibit to output a video signal via the connector when the viewing angle control filter is driven.

### CROSS-REFERENCE TO RELATED APPLICATIONS

This application is based upon and claims the benefit of priority from the prior Japanese Patent Application No. 2005-317693, filed Oct. 31, 2005, the entire contents of which are incorporated herein by reference.

### BACKGROUND

1. Field

Embodiments of the present invention relate to an information processing device and a method for controlling a viewing angle and outputting a video signal to an external display.

2. Description of the Related Art

In recent years, liquid crystal display devices have been widely used as display device for notebook type computers, monitors or the like. Improvements in viewing angle dependency of the liquid crystal display device have progressed and the viewing angle with the same level as that of a CRT has been achieved for the liquid crystal display device.

However, it is important for a display device, mainly for the use of a mobile terminal, etc., to allow a user to view displayed items from the front direction and to make the display device hard to be viewed from the obliquely front direction. This is because, when confidential documents or the like are prepared or read in a public place and the like, the display device intends to prevent persons other than the user from viewing displayed documents or the like. Hence, the display device is structured to allow the user located in front of the display device to read or write a personal mail without caring about the surroundings.

As for a technique to control the viewing angle, a technique using a liquid crystal panel (hereinafter, referred to as a “control filter”) is disclosed (refer to Jpn. Pat. Appln. KOKAI Publication No. 2004-133334). In the technique described in the aforementioned patent document, when the control filter is turned on, a blocking pattern is viewed from the obliquely front direction to protect information on a screen such as a text. Further, even when the control filter is operated, the manner of being viewed from the front is not changed. When the control filter is turned off, the user can view the screen with an original viewing angle of an image display panel for displaying images.

### BRIEF DESCRIPTION OF THE SEVERAL VIEWS OF THE DRAWING

FIG. 1 is an exemplary perspective view showing an example of a schematic configuration of a computer as an information processing device and an external display regarding a first embodiment of the present invention;

FIG. 2 is an exemplary view showing an example of an arrangement relationship between a liquid crystal display (LCD) and a privacy filter regarding the first embodiment;

FIG. 3A and FIG. 3B are exemplary views explaining examples of viewing angle control by the privacy filters, respectively;

FIG. 4 is an exemplary block diagram showing an example of a circuit configuration of the computer regarding the first embodiment of the present invention;

FIG. 5 is an exemplary view showing a setting screen to inhibit a video to be automatically output outward when the privacy filter is driven;

FIG. 6 is an exemplary flowchart showing a procedure of processing capable of inhibiting the video to be output outward when the privacy filter is driven; and

FIG. 7 is an exemplary perspective view showing an example of a schematic configuration of the computer as the information processing device, a docking station as an expansion unit and the external display regarding the first embodiment of the first invention.

### DETAILED DESCRIPTION

Hereinafter, embodiments of the present invention will be described with reference to the drawings.

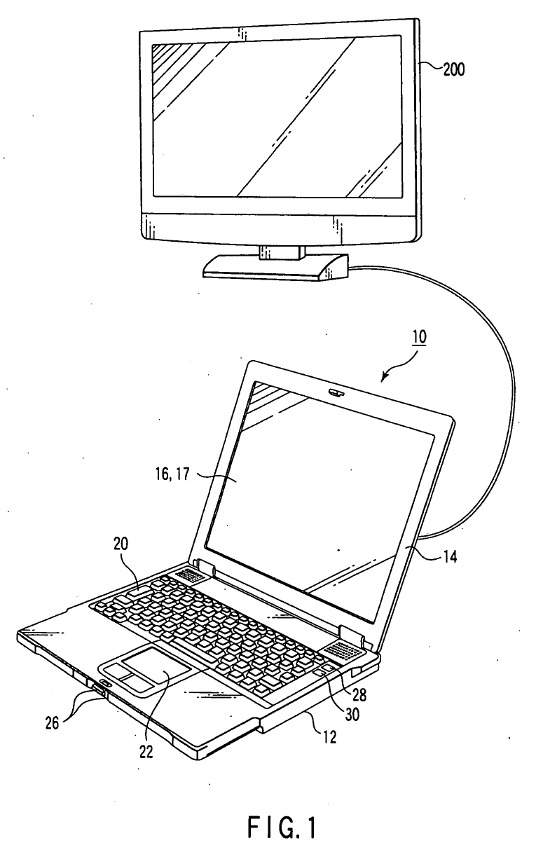

FIG. 1 is an exemplary view showing an example of a computer as an information processing device regarding a first embodiment of the present invention. Of course, the information processing device may be any other device including, but not limited or restricted to a cellular telephone, personal digital assistant or the like.

A computer 10 comprises a computer main body 12 and a display unit 14. An LCD 16 being a display panel and a privacy filter 17 are incorporated in the display unit 14.

The computer 10 can output a video signal to an external display 200 to display a video thereon.

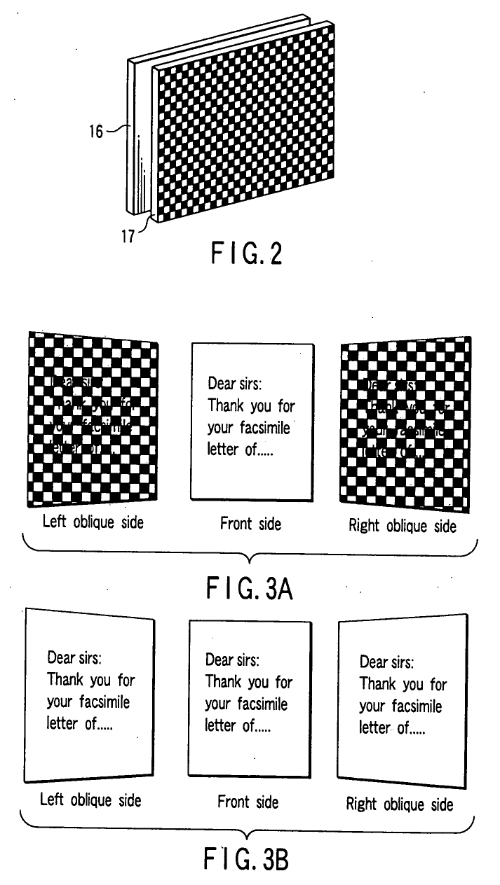

The privacy filter 17 is, as shown in FIG. 2, a viewing angle control filter that is mounted on an image display surface of the LCD 16. The privacy filter 17 may be mounted on a surface on an opposite side of the image display surface of the LCD 16. The computer 10 can use the privacy filter 17 by mounting it within the display unit 14. According to one embodiment of the invention, privacy filter 17 has a polarizer on a panel surface, such as an organic EL panel, a liquid crystal panel and others.

The display unit 14 is attached to a hinge (support unit) 18 disposed at an end on a depth side of the main body 12 so as to vary rotatably between a closing position to cover an upper face of the main body 12 and an opening position to expose the upper face of the main body 12.

The main body 12 has a thin box-shaped housing, and a central part of an upper face of the housing is provided with a keyboard 20 used for an input device. A palm rest is formed on an upper face of a housing part on near side of the main body 12. An almost central part of the palm rest is provided with a touch pad 22 used for another input device, a scroll button 24 and a touch pad control button 26. A power button 28 and a privacy filter button 30 to turn on/off a power source of the main body 12 are arranged on the upper face of the housing part on the depth side of the main body 12.

FIG. 3A and FIG. 3B show exemplary screen viewing angles when the privacy filters 17 are mounted on the LCDs 16, respectively. FIG. 3A illustrates the states of the display screen (from left oblique to right oblique side) when no voltage is applied to the privacy filter 17. In contrast, FIG. 3B shows three states of the display screen when a voltage is applied to the privacy filter 17.

More specifically, as shown within FIG. 3A and FIG. 3B, the left screen indicates how the display screen would be viewed from left oblique side. The central screen image indicates how the display screen would be viewed from front side, and the right screen indicates the screen image as viewed from right oblique side respectively.

As mentioned above, in a state where no voltage is applied, the computer 10 displays the same screen as that displayed even when the screen is viewed from the left or right oblique side.

In contrast, in a state where voltage is applied, the computer 10 produces the same screen as that displayed when the screen is viewed from the front side. However, when the screen is viewed from the left or right oblique side, a blacken part is generated in response to an area disposed on an orientation film to block the display on an LCD device. By displaying such a block figure, the computer 10 makes recognition of the screen from an obliquely lateral direction more difficult and can prevent other persons from reading material displayed on the screen.

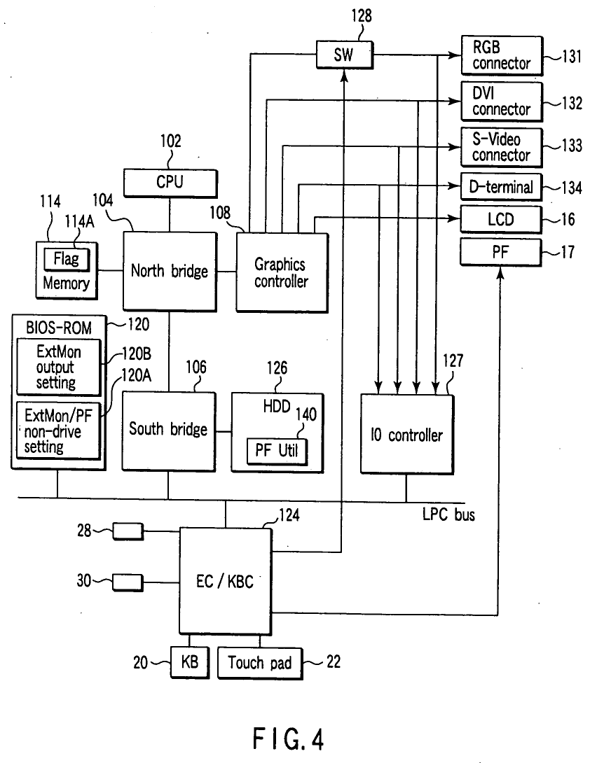

Next, an example of a system configuration of the computer 10 will be described by referring to FIG. 4.

The computer 10 includes, as shown in FIG. 4, a CPU 102, a north bridge 104, a main memory 114, a graphics controller 108 as output means, a south bridge 106, a basic input output system (BIOS)-ROM 120, a hard disk drive (HDD) 126, an embedded controller/keyboard controller (EC/KBC) IC 124, or the like.

The CPU 102 is a processor disposed in order to control operations of the computer 10 and executes an operation system (OS) and a variety of application programs loaded into the main memory 114 from the HDD 126.

The CPU 102 loads a system BIOS stored in the BIOS-ROM 120 then executes it. The system BIOS is a program to control hardware.

The north bridge 104 is a bridge device to connect between a local bus of the CPU 102 and the south bridge 106. A memory controller to control access to the main memory 114 is also incorporated in the north bridge 104. The north bridge 104 also has a function of performing a communication with the graphics controller 108 via an accelerated graphics port (AGP) bus, etc.

The graphics controller 108 is a display controller to control the LCD 16 used as a display monitor of the computer 10. The graphics controller 108 has a video memory (VRAM) and generates a video signal to form a display image to be displayed on the LCD 16 from display data drawn in the VRAM by an OS/application program. The video signal generated by the graphics controller 108 is output to a line.

The graphics controller 108 can further output the video signal to the external display 200 connected to any one of an RGB connector 131, a DVI 132, an S-Video connector 133 and a D-terminal 134. When the external display 200 is connected to any one of the RGB connector 131, DVI 132, S-Video connector 133 and D-terminal 134, the setting whether or not the graphics controller 108 outputs the video signal to the external display 200 is registered in ExtMon output setting 120B in the BIOS-ROM 120. A switch 128 is provided between the RGB connector 131 and the graphics controller 108 to make it possible to control on and off of a video signal output. An instruction from a video BIOS can control the output of the video signal from the graphics controller 108 to the DVI connector 132, S-Video connector 133 and D-terminal 134.

The graphics controller 108 can output the video signal to at least one of the LCD 16 and the external displays connected to the connectors 131 to 134.

The EC/KBC IC (filter control unit) 124 controls the touch pad 22, scroll button 24, and touch pad control button 26 and also functions as a controller to control the driving of the privacy filter 17. According to one embodiment of the invention, the EC/KBC IC 124 is a one-chip microcomputer to monitor and control a variety of devices (peripheral device, sensor, power supply circuit, etc.) regardless of a system state of the computer 10.

Operations of the privacy filter button 30 by a user makes the EC/KBC IC 124 switch on/off a drive signal to the privacy filter 17. The EC/KBC IC 124 notifies a driving state of the privacy filter 17 to the system BIOS. The system BIOS enables (drives) or disables (does not drive) a privacy filter driving flag (PF driving flag) 161 in the main memory 114 in accordance with the driving state of the privacy filter 17.

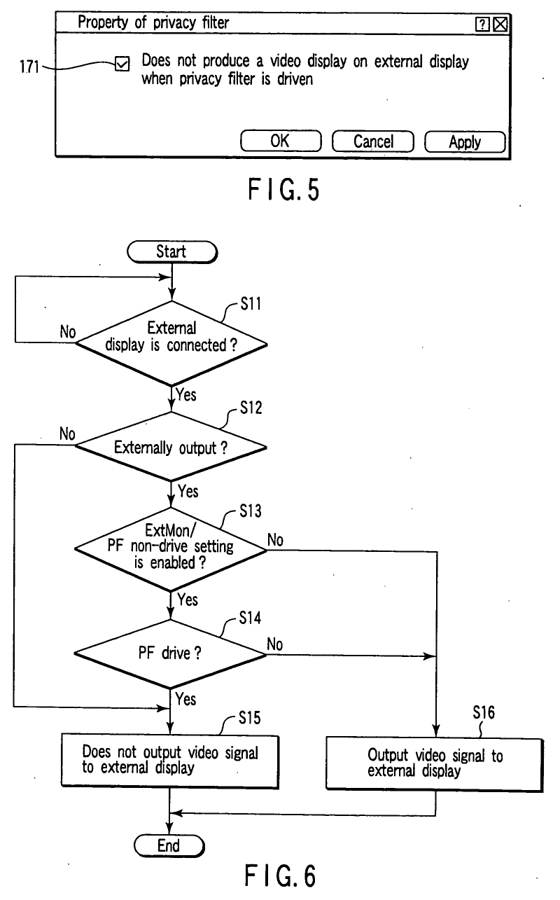

When the external display 200 is connected in a state of driving of the privacy filter 17, the computer 10 can inhibit output of the video signal to the external display 200. A setting window to set this inhibition is displayed as shown in FIG. 5. This setting is displayed though a manner in which a PF utility (PF Util.) 140 stored in the HDD 126 is loaded into the main memory 114 and is executed by the CPU 102.

By putting a check mark into a check box 171 shown in FIG. 5, the computer 10 can inhibit the output of the video signal to the external display 200 in driving the privacy filter 17. This setting is registered in ExtMon/PF non-driving setting 120A in the BIOS-ROM 120 as shown in FIG. 4.

Next to this, a procedure of processing capable of inhibiting the output of the video signal to the external display 200 in driving the privacy filter 17 will be described with reference to the flowchart in FIG. 6.

As generally shown in FIG. 6, the IO controller 127 of FIG. 4 first determines whether or not the external display 200 is connected to any one of the RGB connector 131, DVI 132, S-Video connector 133 and D-terminal 134 (block S11). If the external display 200 is not connected (No, in block S11), the IO controller 127 determines whether or not the external display is connected, at specified timing (block S11).

If the external display 200 is connected (Yes, in block S11), the IO controller 127 notifies to the EC/KBC IC 124 the fact that the external display 200 has been connected. The EC/KBC IC 124 refers to the ExpMon output setting 120B to determine whether or not it is set to output the video signal to the external display 200 (block S12).

If the ExpMon output setting 120B is enabled and it is set to output the video signal to the external display 200 (Yes, in block S12), the EC/KBC IC 124 refers to the ExtMon/PF non-driving setting 120A to determine whether or not it is set not to output the video signal to the external display 200 when the privacy filter 17 is driven (block S13).

If the ExtMon output setting 120B is enabled, if the privacy filter 17 is driving and when it is set not to output the video signal to the external display 200 (Yes, in block S13), the EC/KBC IC 124 determines whether or not the privacy filter has been driven by referring to the privacy filter driving flag 114A (block S14).

If the ExtMon output setting 120B is disabled and when EC/KBC IC 124 is set not to output the video signal to the external display 200 (No, in block S12), or when the privacy filter 17 is driven (Yes, in block S14), the EC/KBC IC 124 operates as an inhibit means to inhibit the video signal to be output via the external output terminal (block S15). The EC/KBC IC 124 turns off the switch 128 inserted between, for example, the RGB connector 131 and graphics controller 108 so as not to output the video signal from the RGB connector 131. Moreover, the EC/KBC IC 124 instructs the video BIOS so as not to output the video signal to the DVI connector 132, S-Video connector 133 and D-terminal 134. The video BIOS instructs the graphics controller 108 so as not to supply the video signal to the external output terminal.

When the ExtMon/PF non-driving setting 120A of FIG. 4 is disabled (No, in block S13) and when the privacy filter flag is disabled (No, in block S14), the EC/KBC IC 124 outputs the video signal to the external display 200 connected to any one of the RGB connector 131, DVI 132, S-Video connector 133 and D-terminal 134.

As mentioned above, the driving of the privacy filter 17 can enhance the confidentiality of the information by inhibiting the video signal to be input to the external display 200. The computer 10 can simplify operations of the user by controlling the output from the external display 200 in response to the driving state of the privacy filter 17.

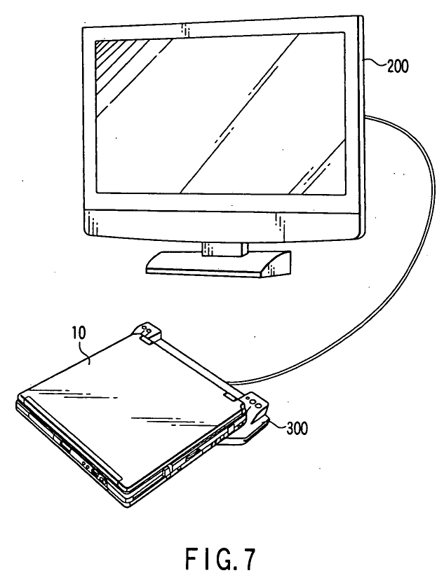

As shown in FIG. 7, the computer 10 can optionally output the video signal to the external display 200 via a docking station 300. Even in such a case, the IO controller 127 may detect whether or not the external display 200 is connected to the docking station 300 in the block S11. As like the foregoing description, when the IO controller 127 detects the connection of the external display 200 to the docking station 300, the computer 10 may determine whether the video signal should be or not be output to the external display 200 connected to the docking station 300 in accordance with the ExtMon output setting 120B of FIG. 4, ExtMon/PF non-driving setting 120A of FIG. 4 and PF driving flag 114A of FIG. 4.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An information processing device adapted for communication with an external display, comprising:
a display panel;
a viewing angle control filter to control a viewing angle;
a connector to be connected to the external display; and
a controller to inhibit output of a video signal via the connector when the viewing angle control filter is driven.

2. The information processing device according to claim 1 further comprising a memory device accessible by the controller, the memory device to store a first setting that, when set, causes the controller to inhibit the output of the video signal via the connector.

3. The information processing device according to claim 1 further comprising:
a graphics controller to output the video signal to be displayed by at least one of the display panel and the external display; and
a switch in communication with the controller, the switch being disposed between the connector and the graphics controller.

4. The information processing device according to claim 1 further comprising an output unit configured to output a video signal to be displayed at least one of the display panel and the external display, the output unit including a plurality of connectors including the connector.

5. The information processing device according to claim 1 further comprising a main body including the connector to be connected to an expansion unit and further including a second connector to be connected to the external display, wherein the controller to inhibit output of the video signal via the second connector disposed at the expansion unit when the viewing angle control filter is driven.

6. The information processing device according to claim 1, wherein the viewing angle control filter is disposed at the display panel and arranged facing one face of the display panel.

7. An information processing device, comprising:
a main body including a housing provided with an input device;
a display unit coupled to a hinge disposed at an end of the main body, the display unit including a display panel;
a viewing angle control filter to control a viewing angle associated with the display panel;
a connector to be connected to an external display; and
means for inhibiting an output of a video signal via the connector when the viewing angle control filter is driven.

8. The information processing device according to claim 7, further comprising means for setting whether to inhibit the output of the video signal via the connector when the viewing angle control filter is driven.

9. The information processing device according to claim 7 further comprising:
means for outputting a video signal to be displayed by at least one of the display panel and the external display; and
a switch disposed between the connector and the means for outputting, wherein the means for inhibiting to turn off the switch when the viewing angle control filter is driven.

10. The information processing device according to claim 7 further comprising a graphics controller to output the video signal to be displayed by at least one of the display panel and the external display.

11. The information processing device according to claim 7, wherein the connector is connected to an expansion unit including a second connector to be connected to an external display, the means for inhibiting prevents the output of the video signal via the second connector disposed at the expansion unit when the viewing angle control filter is driven.

12. The information processing device according to claim 7, wherein the viewing angle control filter is disposed at the display panel and arranged facing one face of the display panel.

13. The information processing device according to claim 7, wherein the input device includes a keyboard.

14. The information processing device according to claim 7, wherein the input device includes a touch pad.

15. The information processing device according to claim 7 further comprising a viewing angle control switch disposed on the main body and configured to drive the viewing angle control filter.

16. A method for controlling a viewing angle for an information processing device including a connector to be connected to an external display, a display panel, a viewing angle control filter and an output of a video signal for display on at least one of the display panel and the external display, comprising:
detecting whether the viewing angle control filter is driven; and
inhibiting output of the video signal via the connector when the viewing angle control filter is driven.

17. The method according to claim 16, wherein the inhibiting of the output of the video signal is performed by a controller detecting that the viewing angle control filter is driven and causing inhibition of the output of the video signal via the connector when the viewing angle control filter is driven.

18. The method according to claim 17, wherein inhibition of outputting of the video signal includes turning off a switch disposed between the connector and a graphic controller when the viewing angle control filter is driven.

19. A method according to claim 16, wherein inhibition of outputting of the video signal includes stopping an output of the video signal from a graphics controller.

20. A method according to claim 16, wherein the inhibit unit includes a second inhibit unit configure to inhibit a video signal to be output via a second connector which is disposed at an expansion unit connectable to a main body with the connector disposed thereto and to which an external display is connectable when the viewing angle control filter is driven.
